(19) United States
(12) Patent Application Publication
(10) Pub. No.: US 2022/0399606 A1
(43) Pub. Date: Dec. 15, 2022

(54) BATTERY CASE

(71) Applicant: TOYOTA JIDOSHA KABUSHIKI KAISHA, Toyota-shi (JP)

(72) Inventors: Shintaro UTSUMI, Susono-shi (JP); Yuya KUMASAKA, Susono-shi (JP); Shunsuke NAGATA, Nagakute-shi (JP); Hiroshi ENDO, Toyota-shi (JP); Yuko AZUMA, Numazu-shi (JP); Nobuyoshi FUJIWARA, Mishima-shi (JP)

(73) Assignee: TOYOTA JIDOSHA KABUSHIKI KAISHA, Toyota-shi (JP)

(21) Appl. No.: 17/833,116

(22) Filed: Jun. 6, 2022

(30) Foreign Application Priority Data
Jun. 11, 2021 (JP) 2021-098125

(51) Int. Cl. H01M 50/242

(52) U.S. Cl. CPC H01M 50/242

(57) ABSTRACT

A battery case includes a housing configured to accommodate a battery stack, and an abutting wall portion that is cast integrally with the housing on an inner side of the housing. The abutting wall portion is configured to bear a load from the battery stack accommodated in the housing. The battery case further includes a reinforcing part that is made of a material more rigid than the abutting wall portion and that is cast into the abutting wall portion by enveloped casting.

### CROSS-REFERENCE TO RELATED APPLICATION

This application claims priority to Japanese Patent Application No. 2021-098125 filed on Jun. 11, 2021, incorporated herein by reference in its entirety.

### BACKGROUND

### 1. Technical Field

The present disclosure relates to a battery case included in a battery pack, and more particularly relates to a battery case for accommodating a battery stack pressurized in a stacking direction.

### 2. Description of Related Art

Japanese Patent No. 6686823 (JP 6686823 B) discloses a method of installing a battery stack, in which the battery stack is conveyed into a storage case in a state of being gripped between gripping members with at least part of the gripping members inserted into openings formed on outer faces of end plates, and thereafter extracting the gripping members from stack-side opening portions.

### SUMMARY

Although reduction in size of a battery pack is an object of the above-described related art, there is room for improvement in reduction of size of the build of the battery stack in the stacking direction thereof.

The present disclosure provides a battery case that enables reduction in size of build of a battery pack in the stacking direction of a battery stack.

The battery case according to an aspect of the present disclosure includes a housing configured to accommodate a battery stack that is pressurized in a stacking direction, an abutting wall portion that is cast integrally with the housing on an inner side of the housing, and a reinforcing part that is cast into the abutting wall portion by enveloped casting. The abutting wall portion is configured to bear a load from the battery stack accommodated in the housing. The reinforcing part is made of a material more rigid than the abutting wall portion.

In the battery case according to an aspect of the present disclosure, a side end of the reinforcing part may extend to at least one of side walls of the housing. The abutting wall portion may be connected to the at least one of the side walls. The housing may include a pair of the side walls, and the abutting wall portion may be connected to both of the side walls. The reinforcing part may include a flange at the side end, and the flange may be embedded in the at least one of the side walls. A lower end of the reinforcing part may extend to a bottom plate of the housing to which the abutting wall portion may be connected. The reinforcing part may be a part including a screw hole configured such that another part is attached to the battery case. The reinforcing part may be embedded in the abutting wall portion. The abutting wall portion may include a first abutting wall and a second abutting wall that are provided on the inner side of the housing.

In the battery case according to an aspect of the present disclosure, the reinforcing part that is made of a material more rigid than the abutting wall portion is cast by enveloped casting into the abutting wall portion configured to bear a load from the battery stack accommodated in the housing. The load applied to the abutting wall portion is borne by the reinforcing part, and accordingly the wall thickness of the abutting wall portion can be made thinner than when the reinforcing part is not included. This enables reduction in size of the build of the battery pack in the stacking direction of the battery stack.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1A is a longitudinal-sectional view illustrating a configuration of a battery case according to a first embodiment of the present disclosure;

FIG. 1B is a cross-sectional view illustrating the configuration of the battery case according to the first embodiment of the present disclosure;

FIG. 2A is a longitudinal-sectional view illustrating a configuration of a battery pack using the battery case illustrated in FIGS. 1A and 1B;

FIG. 2B is a cross-sectional view illustrating the configuration of the battery pack using the battery case illustrated in FIGS. 1A and 1B;

FIG. 3A is a longitudinal-sectional view illustrating a configuration of a battery case according to a second embodiment of the present disclosure; and

FIG. 3B is a cross-sectional view illustrating the configuration of the battery case according to the second embodiment of the present disclosure.

### DETAILED DESCRIPTION OF EMBODIMENTS

An embodiment of the present disclosure will be described below with reference to the drawings. It should be noted though, that when a count, a quantity, an amount, a range, or the like, of each element, is stated in the following embodiments, the technical idea of the present disclosure is not limited to the stated number unless otherwise specified in particular, or when obviously limited to the stated number in principle. Also, configurations and the like described in the following embodiments are not necessarily essential to the technical idea of the present disclosure, unless otherwise specified in particular or when obviously limited thereto in principle.

### 1. First Embodiment

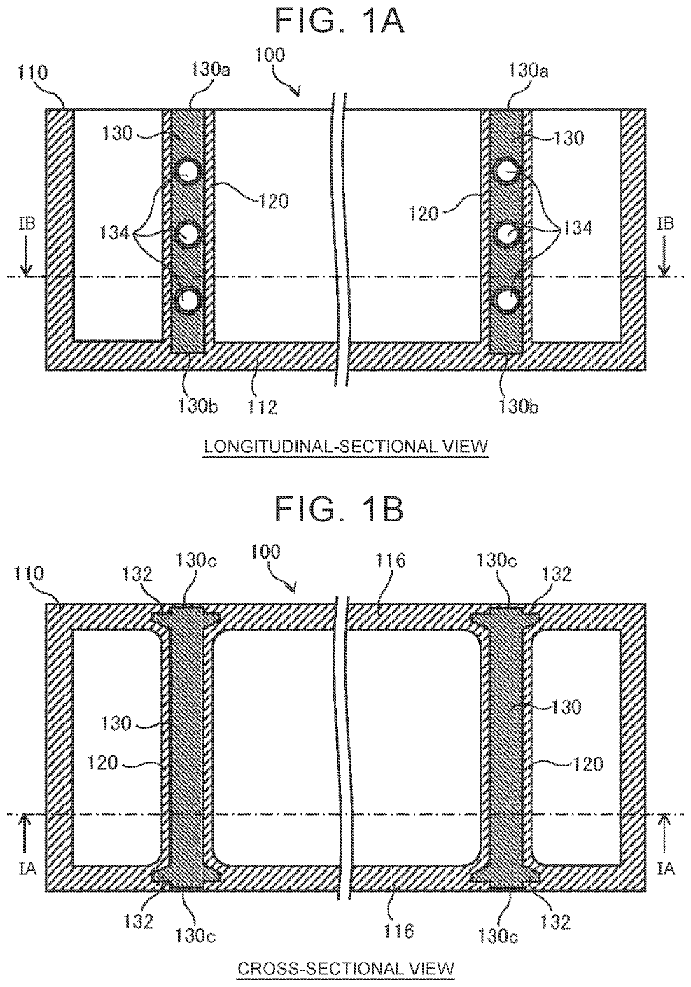

FIGS. 1A and 1B respectively are a longitudinal-sectional view and a cross-sectional view illustrating a configuration of a battery case 100 according to a first embodiment of the present disclosure. The cross-sectional view (FIG. 1B) is a sectional view taken along line IB-IB in the longitudinal-sectional view (FIG. 1A), and the longitudinal-sectional view (FIG. 1A) is a sectional view taken along line IA-IA in the cross-sectional view (FIG. 1B).

The battery case 100 includes a bathtub-shaped housing 110, and a pair of abutting walls (also referred to as bulkheads) 120 that is provided on an inner side of the housing 110. The right and left ends of the abutting walls 120 are connected to a pair of side walls 116 of the housing 110, and the lower ends of the abutting walls 120 are connected to a bottom plate 112 of the housing 110. The battery case 100 is a cast article made of a light metal, aluminum to be specific, and more particularly is a die-cast product. The housing 110 and the abutting walls 120 are integrally cast by die casting.

Reinforcing parts 130 are embedded in the abutting walls 120. The reinforcing parts 130 are plate-shaped solid metal parts. The reinforcing parts 130 are made of a material having a higher rigidity than the abutting walls 120, for example, a metal material such as iron or stainless steel. Using an iron-based material for the material of the reinforcing parts 130 enables costs to be suppressed. Enveloped casting is used as the method of embedding the reinforcing parts 130 in the abutting walls 120. That is to say, the reinforcing parts 130 are prepared, molten light metal, which is the material of the housing 110 and the abutting walls 120, is poured around the prepared reinforcing parts 130, and the molten light metal is cooled, thereby forming a cast article in which the reinforcing parts 130 are integrally formed with the abutting walls 120.

As illustrated in the cross-sectional view (FIG. 1B), side ends 130c at both sides of the reinforcing parts 130 extend to the side walls 116 of the housing 110. The reinforcing parts 130 are provided with flanges 132 at the side ends 130c. The flanges 132 are embedded in the side walls 116. This ensures high rigidity between the abutting walls 120 and the side walls 116. Further, the side ends 130c of the reinforcing parts 130 are partially exposed at the surfaces of the side walls 116. Screw holes 134 are provided in the portions of the reinforcing parts 130 exposed at the surface of the side walls 116, as can be understood from the portions illustrated in the longitudinal-sectional view (FIG. 1A). The screw holes 134 are used to fasten other parts to the battery case 100 by bolts. The screw holes 134 are formed in the reinforcing parts 130, and accordingly other parts can be directly fastened to the highly-rigid reinforcing parts 130.

Further, as illustrated in the longitudinal-sectional view (FIG. 1A), lower ends 130b of the reinforcing parts 130 extend to the bottom plate 112 of the housing 110. This ensures rigidity between the abutting walls 120 and the bottom plate 112. When another part is to be fastened to the bottom plate 112 of the housing 110, the lower ends 130b of the reinforcing parts 130 may be partially exposed at the surface of the bottom plate 112, although this is omitted from illustration. That is to say, an arrangement may be made in which other parts can be directly fastened to the highly-rigid reinforcing parts 130. As an example of means for fastening, screw holes may be provided at the lower ends 130b of the reinforcing parts 130. Although the upper ends 130a of the reinforcing parts 130 are illustrated as being exposed at the upper faces of the abutting walls 120 in the longitudinal-sectional view (FIG. 1A), arrangements may be made in which part or none of the upper ends 130a are exposed.

Providing the reinforcing parts 130 as described above enables the rigidity of the abutting walls 120 to be improved. The wall thickness of the abutting walls 120 required to obtain the same rigidity can be reduced as compared with when the reinforcing parts 130 are not provided.

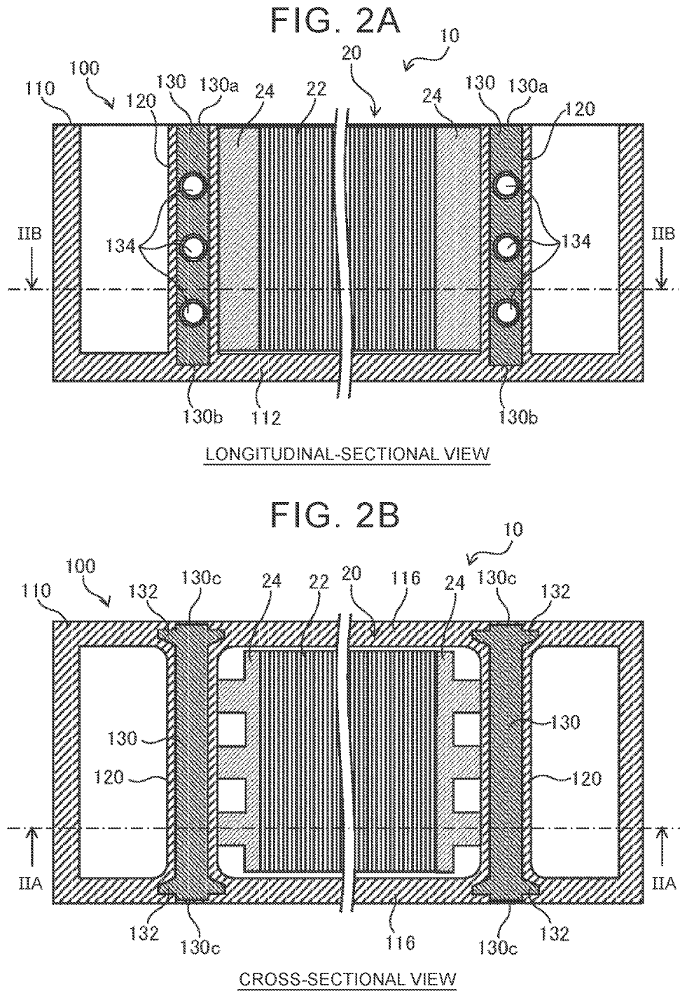

FIGS. 2A and 2B respectively are a longitudinal-sectional view and a cross-sectional view illustrating a configuration of a battery pack 10 according to the first embodiment of the present disclosure. The cross-sectional view (FIG. 2B) is a sectional view taken along line IIB-IIB in the longitudinal-sectional view (FIG. 2A), and the longitudinal-sectional view (FIG. 2A) is a sectional view taken along line IIA-IIA in the cross-sectional view (FIG. 2B).

The battery pack 10 is used as a power source for an electrified vehicle including, for example, a battery electric vehicle (BEV), a plug-in hybrid electric vehicle (PHEV), and a hybrid electric vehicle (HEV). One or more battery packs 10 are installed under a floor, under a seat, or the like, of the electrified vehicle. The battery pack 10 is configured by accommodating a battery stack 20 in the battery case 100 described above.

The battery stack 20 includes a great number of battery cells 22 stacked together. The battery cells 22 are secondary batteries that can be discharged/recharged, and are lithium ion secondary batteries, for example. In the sectional views of FIGS. 2A and 2B, a right-left direction is a stacking direction of the battery cells 22 in the battery stack 20. The battery stack 20 includes a pair of end plates 24, each at corresponding one of ends in the stacking direction of the battery cells 22.

The battery stack 20 is pressurized in the stacking direction of the battery cells 22, and is conveyed into the battery case 100 in a state in which a high compressive force is applied and the length of the battery stack 20 is shortened. Accordingly, when installed in the battery case 100, the battery stack 20 seeks to expand in a length direction thereof, i.e., in the stacking direction of the battery cells 22. However, the expansion of the battery stack 20 in the length direction is hindered by the end plates 24 striking against the abutting walls 120. That is to say, the battery stack 20 is constrained by the abutting walls 120 located in the length direction thereof (the stacking direction of the battery cells 22).

In the battery case 100 according to the present embodiment, the abutting walls 120 that bear the load from the battery stack 20 accommodated in the housing 110 are provided with the reinforcing parts 130 made of a material that has a higher rigidity than the abutting walls 120. Accordingly, the load applied to the abutting walls 120 is borne by the highly-rigid reinforcing parts 130, and deflection of the abutting walls 120 due to the load from the battery stack 20 is suppressed. Also, by being provided with the reinforcing parts 130, buckling of the abutting walls 120 under a load from a direction perpendicular to the stacking direction of the battery stack 20 can be suppressed.

Further, the abutting walls 120 are reinforced by the reinforcing parts 130 in the battery case 100 according to the present embodiment, and accordingly the wall thickness of the abutting walls 120 can be made thinner than when the reinforcing parts 130 are not included. This enables reduction in size of the build of the battery pack 10 in the stacking direction of the battery stack 20.

### 2. Second Embodiment

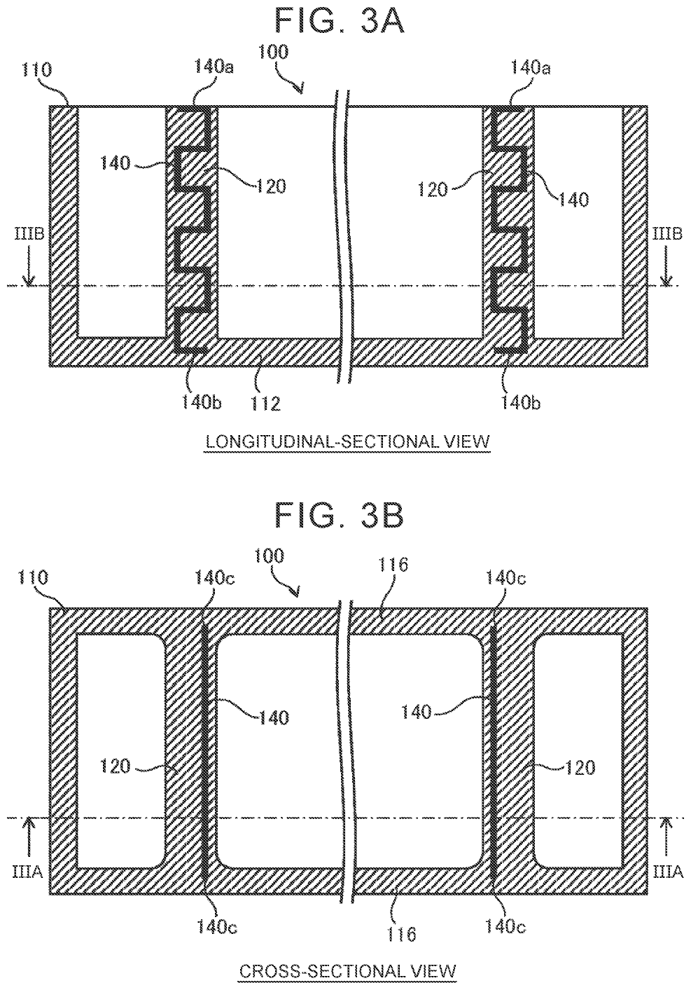

FIGS. 3A and 3B respectively are a longitudinal-sectional view and a cross-sectional view illustrating a configuration of a battery case 100 according to a second embodiment of the present disclosure. The cross-sectional view (FIG. 3B) is a sectional view taken along line IIIB-IIIB in the longitudinal-sectional view (FIG. 3A), and the longitudinal-sectional view (FIG. 3A) is a sectional view taken along line IIIA-IIIA in the cross-sectional view (FIG. 3B).

Although the reinforcing parts 130 are made of thickly-formed plates in the first embodiment, the parts making up the battery case 100 may be lighter from the viewpoint of fuel efficiency. Accordingly, reinforcing parts 140 formed of sheet metal are used in the second embodiment. The material of the sheet metal is a metal material such as iron or stainless steel, which has higher rigidity than the light metal forming the abutting walls 120. The reinforcing parts 140 are integrally formed with the abutting walls 120 by enveloped casting. That is to say, the reinforcing parts 140 are embedded in the abutting walls 120.

As illustrated in the longitudinal-sectional view (FIG. 3A), the reinforcing parts 140 are formed in a corrugated shape. Due to this corrugated shape, a sufficient sectional secondary moment is secured for the reinforcing parts 140. Securing the sectional secondary moment by the reinforcing parts 140 enables deflection of the abutting walls 120 under a load from the stacking direction of the battery stack, and buckling of the abutting walls 120 under a load from the direction perpendicular to the stacking direction of the battery stack, to be suppressed. Including such reinforcing parts 140 enables the wall thickness of the abutting walls 120 to be made thinner than when no reinforcing parts 140 are included. This enables reduction in size of the build of the battery pack in the stacking direction of the battery stack.

### 3. Other Embodiments

In the above-described embodiments, the reinforcing parts 130 (or 140) are provided in both of the abutting walls 120. However, an arrangement may be made in which the reinforcing part 130 (or 140) is provided in only one of the abutting walls 120. Also, the shapes and materials of the reinforcing parts may be made to be different between the right and left abutting walls 120, such as providing the reinforcing part 130 in one abutting wall 120 and providing the reinforcing part 140 in the other abutting wall 120.

Also, the abutting walls 120 are provided as a pair inside the housing 110 in the above-described embodiments. However, an arrangement may be made in which only one abutting wall 120 is provided, and the battery stack 20 is accommodated between a front end or a rear end wall of the housing 110 and the abutting wall 120.

What is claimed is:

1. A battery case, comprising:
a housing configured to accommodate a battery stack that is pressurized in a stacking direction;
an abutting wall portion that is cast integrally with the housing on an inner side of the housing, and that is configured to bear a load from the battery stack accommodated in the housing; and
a reinforcing part that is made of a material more rigid than the abutting wall portion and that is cast into the abutting wall portion by enveloped casting.

2. The battery case according to claim 1, wherein a side end of the reinforcing part extends to at least one of side walls of the housing, the abutting wall portion being connected to the at least one of the side walls.

3. The battery case according to claim 2, wherein:
the housing includes a pair of the side walls; and
the abutting wall portion is connected to both of the side walls.

4. The battery case according to claim 2, wherein the reinforcing part includes a flange at the side end, and the flange is embedded in the at least one of the side walls.

5. The battery case according to claim 1, wherein a lower end of the reinforcing part extends to a bottom plate of the housing to which the abutting wall portion is connected.

6. The battery case according to claim 1, wherein the reinforcing part is a part including a screw hole configured such that another part is attached to the battery case.

7. The battery case according to claim 1, wherein the reinforcing part is embedded in the abutting wall portion.

8. The battery case according to claim 1, wherein the abutting wall portion includes a first abutting wall and a second abutting wall that are provided on the inner side of the housing.
